(19) United States
(12) Patent Application Publication
(10) Pub. No.: US 2019/0078294 A1
(43) Pub. Date: Mar. 14, 2019

(54) SHAPE MEASUREMENT SYSTEM, WORK MACHINE, AND SHAPE MEASUREMENT METHOD

(71) Applicant: Komatsu Ltd., Tokyo (JP)

(72) Inventors: Atsushi Nagato, Tokyo (JP); Taiki Sugawara, Tokyo (JP); Hiroyoshi Yamaguchi, Tokyo (JP)

(21) Appl. No.: 16/084,740

(22) PCT Filed: May 26, 2017
(86) PCT No.: PCT/JP2017/019717

§ 371 Date: Sep. 13, 2018

(30) Foreign Application Priority Data
May 31, 2016 (JP) 2016-109578

(51) Int. Cl. E02F 9/20; E02F 9/26; G01B 11/245; G01C 11/06

(52) U.S. Cl. CPC E02F 9/2004; G01C 11/06; G01B 11/245; E02F 9/26

(57) ABSTRACT

A shape measurement system includes a target detection unit, attached to a work machine, configured to detect a target worked on by the work machine, and configured to output information about the target, a calculation unit configured to obtain shape information indicating a three-dimensional shape of the target, by using the information about the target detected by the target detection unit, and configured to output the shape information, and a changing unit configured to change a measurement condition used when the calculation unit obtains the shape information. The measurement condition is a range of the information about the target used when the calculation unit obtains the shape information.

### FIELD

The present invention relates to a shape measurement system which measures a position of a target, a work machine provided with the shape measurement system, and a shape measurement method for measuring a position of a target.

### BACKGROUND

There is a work machine which is provided with an imaging device. Patent Literature 1 describes a technique for creating construction plan image data based on construction plan data stored in a memory unit and position information of a stereo camera, for combining the construction plan image data and current state image data captured by the stereo camera, and for three-dimensionally displaying a combined synthetic image on a three-dimensional display device.

### CITATION LIST

### Patent Literature

Patent Literature 1: Japanese Laid-open Patent Publication No. 2013-036243 A

### SUMMARY

### Technical Problem

There are demands to change a measurement condition which is used at the time of stereoscopic image processing, such as demands to change a capturing range of a stereo camera or to change resolution of data captured by the stereo camera. Patent Literature 1 does not describe or suggest such changing of the measurement condition, and there is a room for improvement.

The present invention has its object to change a measurement condition which is used at the time of performing stereoscopic image processing.

### Solution to Problem

According to a first aspect of the present invention, a shape measurement system comprises: a target detection unit, attached to a work machine, configured to detect a target in a periphery of the work machine; and a calculation unit configured to obtain shape information indicating a three-dimensional shape of the target, by using a detection result detected by the target detection unit, wherein the calculation unit is configured to change a range where the shape information is obtained.

According to a second aspect of the present invention, in the first aspect, attribute information about accuracy of a position is added to the shape information.

According to a third aspect of the present invention, in the first aspect, the calculation unit is configured to receive a signal for changing the range where the shape information is obtained, from a management device, a mobile terminal device, or an input device of the work machine.

According to a fourth aspect of the present invention, in the second aspect, in a case of a first measurement range that is a range where the shape information of the target is obtained, information indicating that accuracy of the position is high is added to the shape information, for a measurement result for the first measurement range.

According to a fifth aspect of the present invention, in the fourth aspect, in a region excluding the first measurement range from a second measurement range that is a region larger than the first measurement range and where the shape information of the target is obtained, information indicating that accuracy of the position is low is added to the shape information, for a measurement result for the region.

According to a sixth aspect of the present invention, in the second aspect, the attribute information about accuracy of the position, which is added to a measured position, is changed according to a distance of the measured position from the target detection unit.

According to a seventh aspect of the present invention, in the second aspect, the shape measurement system comprises a display device configured to display the attribute information about accuracy of the position, together with the shape information.

According to an eighth aspect of the present invention, in the second aspect, the shape information is divided into a plurality of cells, and each cell includes position information of the target and the attribute information about accuracy of the position.

According to a ninth aspect of the present invention, in the second aspect, the shape information is divided into a plurality of cells, and the calculation unit is configured to obtain the position information of a cell not including the position information of the target, by using at least two of the cells including the position information of the target.

According to a tenth aspect of the present invention, in the second aspect, the shape information is divided into a plurality of cells, and sizes of the cells are set to increase as a distance from a position of the target detection unit is increased.

According to an eleventh aspect of the present invention, a work machine comprises a shape measurement system according to any one of the aspects 1 to 10.

According to a twelfth aspect of the present invention, a shape measurement method comprises: detecting, by a work machine, a target in a periphery of the work machine; and obtaining shape information indicating a three-dimensional shape of the target, by using a result of the detecting, and outputting the shape information, wherein a range where the shape information is obtained is changeable.

### Advantageous Effects of Invention

According to an aspect of the present invention, a measurement condition which is used at the time of performing stereoscopic image processing can be changed.

### BRIEF DESCRIPTION OF DRAWINGS

FIG. 1 is a perspective view illustrating an excavator according to an embodiment.

FIG. 2 is a perspective view of and around a driver's seat of the excavator according to the embodiment.

FIG. 3 is a diagram illustrating a shape measurement system, a control system of a work machine, and a construction management system according to the embodiment.

FIG. 4 is a diagram illustrating an example hardware configuration of a detection processing device of the shape measurement system, various appliances of the control system of the work machine, and a management device.

FIG. 5 is a diagram for describing shape information obtained by the shape measurement system of the work machine according to the embodiment.

FIG. 6 is a diagram illustrating a range of measurement for the shape information of a target.

FIG. 7 is a diagram illustrating cells included in the shape information.

FIG. 8 is a diagram illustrating an example in which a display device performs display in a manner allowing identification of attribute information about accuracy of a measured position.

FIG. 9 is a diagram illustrating cells including the position information and a cell not including the position information.

FIG. 10 is a diagram illustrating a noise and a work unit included in shape information.

### DESCRIPTION OF EMBODIMENTS

A mode (embodiment) of carrying out the present invention will be described in detail with reference to the drawings.

<Overall Configuration of Excavator>

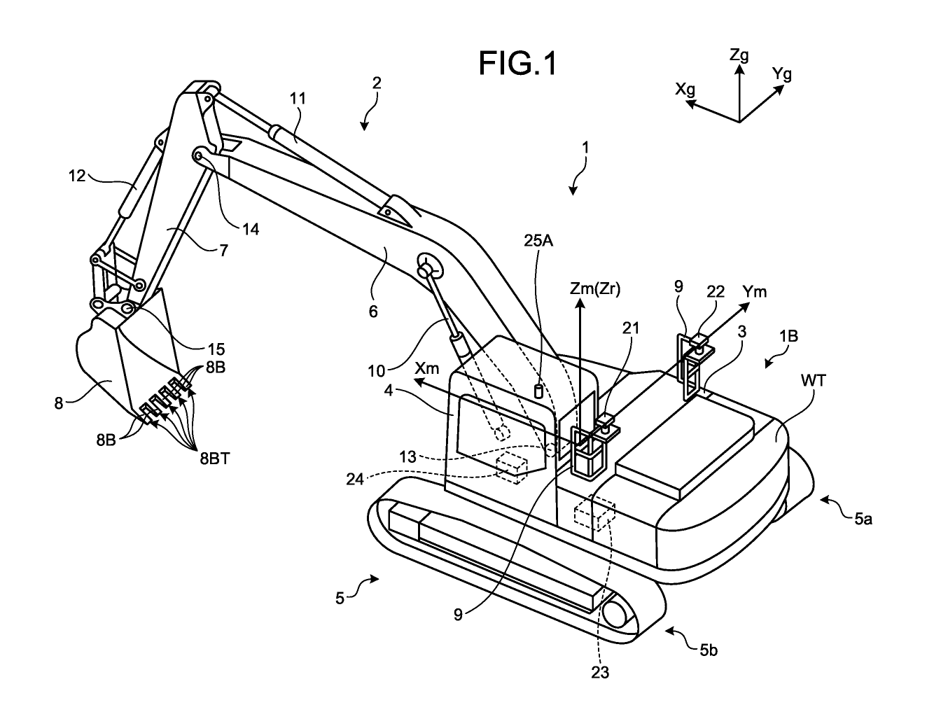

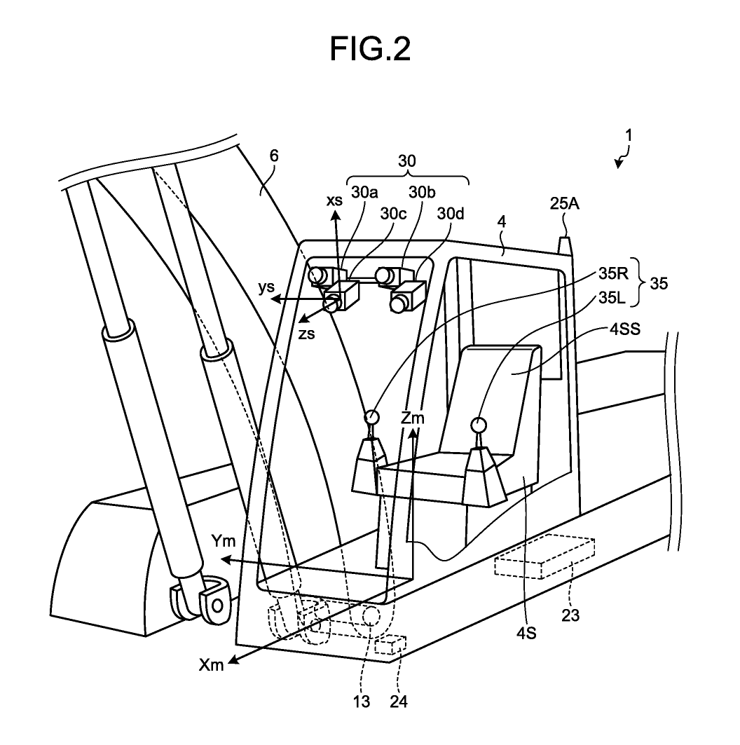

FIG. 1 is a perspective view illustrating an excavator 1 according to an embodiment. FIG. 2 is a perspective view of and around a driver's seat of the excavator 1 according to the embodiment. The excavator 1, which is a work machine, includes a vehicle body 1B and a work unit 2. The vehicle body 1B includes a swinging body 3, a cab 4, and a traveling body 5. The swinging body 3 is attached to the traveling body 5 in a manner capable of swinging around a swing center axis Zr. The swinging body 3 houses devices such as a hydraulic pump and an engine.

The work unit 2 is attached to the swinging body 3, and the swinging body 3 is configured to swing. Handrails 9 are attached to an upper part of the swinging body 3. Antennas 21, 22 are attached to the handrails 9. The antennas 21, 22 are antennas for global navigation satellite systems (GNSS). The antennas 21, 22 are arranged along a direction parallel to a Ym-axis of a vehicle body coordinate system (Xm, Ym, Zm) while being separate from each other by a specific distance. The antennas 21, 22 receive GNSS radio waves, and output signals according to the received GNSS radio waves. The antennas 21, 22 may alternatively be antennas for a global positioning system (GPS).

The cab 4 is mounted at a front part of the swinging body 3. A communication antenna 25A is attached to a roof of the cab 4. The traveling body 5 includes crawler belts 5a, 5b. The excavator 1 travels by rotation of the crawler belts 5a, 5b.

The work unit 2 is attached to a front part of the vehicle body 1B. The work unit 2 includes a boom 6, an arm 7, a bucket 8 as a work tool, a boom cylinder 10, an arm cylinder 11, and a bucket cylinder 12. In the embodiment, a front side of the vehicle body 1B is a side of an operation device 35 with respect to a backrest 4SS of a driver's seat 4S illustrated in FIG. 2. A rear side of the vehicle body 1B is a side of the backrest 4SS of the driver's seat 4S with respect to the operation device 35. The front part of the vehicle body 1B is a part on the front side of the vehicle body 1B, and is a part opposite a counterweight WT of the vehicle body 1B. The operation device 35 is a device for operating the work unit 2 and the swinging body 3, and includes a right lever 35R and a left lever 35L.

A proximal end part of the boom 6 is rotatably attached through a boom pin 13 to the front part of the vehicle body 1B. A proximal end part of the arm 7 is rotatably attached through an arm pin 14 to a distal end part of the boom 6. The bucket 8 is rotatably attached through a bucket pin 15 to a distal end part of the arm 7.

The boom cylinder 10, the arm cylinder 11, and the bucket cylinder 12 illustrated in FIG. 1 are each a hydraulic cylinder that is driven by pressure of hydraulic oil, i.e., hydraulic pressure. The boom cylinder 10 drives the boom 6 by being extended or retracted by hydraulic pressure. The arm cylinder 11 drives the arm 7 by being extended or retracted by hydraulic pressure. The bucket cylinder 12 drives the bucket 8 by being extended or retracted by hydraulic pressure.

The bucket 8 includes a plurality of blades 8B. The plurality of blades 8B are aligned in a line along a width direction of the bucket 8. A tip end of the blade 8B is a blade tip 8BT. The bucket 8 is an example of a work tool. The work tool is not limited to the bucket 8.

The swinging body 3 includes a position detection device 23, and an inertial measurement unit (IMU) 24, which is an example of a posture detection device. The position detection device 23 detects, and outputs, current positions of the antennas 21, 22 and orientation of the swinging body 3 in a global coordinate system (Xg, Yg, Zg) by using signals acquired from the antennas 21, 22. The orientation of the swinging body 3 indicates a direction the swinging body 3 is facing in the global coordinate system. For example, the direction the swinging body 3 is facing may be indicated by a direction along a front-back direction of the swinging body 3 with respect to a Zg-axis of the global coordinate system. An orientation angle is a rotation angle of a reference axis along the front-back direction of the swinging body 3 around the Zg-axis of the global coordinate system. The orientation of the swinging body 3 is indicated by the orientation angle.

<Imaging Device>

As illustrated in FIG. 2, the excavator 1 includes a plurality of imaging devices 30a, 30b, 30c, 30d inside the cab 4. The plurality of imaging devices 30a, 30b, 30c, 30d are an example of a target detection unit configured to detect a shape of a target. In the following, the plurality of imaging devices 30a, 30b, 30c, 30d are referred to as “imaging device(s) 30” when the imaging devices 30a, 30b, 30c, 30d do not have to be distinguished from one another. Of the plurality of imaging devices 30, the imaging device 30a and the imaging device 30c are arranged on the work unit 2 side. The type of the imaging devices 30 is not limited, but in the embodiment, imaging devices provided with a couple charged device (CCD) image sensor or a complementary metal oxide semiconductor (CMOS) image sensor are used.

As illustrated in FIG. 2, the imaging device 30a and the imaging device 30b are arranged inside the cab 4 while facing a same direction or different directions, with a predetermined gap therebetween. The imaging device 30c and the imaging device 30d are arranged inside the cab 4 while facing a same direction or different directions, with a predetermined gap therebetween. Two of the plurality of imaging devices 30a, 30b, 30c, 30d are combined to configure a stereo camera. In the embodiment, a stereo camera is configured by a combination of the imaging devices 30a, 30b, and a stereo camera is configured by a combination of the imaging devices 30c, 30d.

In the embodiment, the imaging device 30a and the imaging device 30b face upward, and the imaging device 30c and the imaging device 30d face downward. At least the imaging device 30a and the imaging device 30c face the front side of the excavator 1, or in the embodiment, the swinging body 3. The imaging device 30b and the imaging device 30d may be arranged facing slightly toward the work unit 2, or in other words, facing slightly toward the side of the imaging device 30a and the imaging device 30c.

In the embodiment, the excavator 1 includes four imaging devices 30, but it is sufficient if the excavator 1 includes at least two imaging devices 30, without being limited to four. This is because, with the excavator 1, a stereo camera is configured by at least a pair of imaging devices 30 to stereoscopically capture a target.

The plurality of imaging devices 30a, 30b, 30c, 30d are arranged forward and upward inside the cab 4. Upward is a direction perpendicular to a ground contact surface of the crawler belt 5a, 5b of the excavator 1, the direction facing away from the ground contact surface. The ground contact surface of the crawler belt 5a, 5b is a plane of a part of at least one of the crawler belts 5a, 5b in contact with the ground, the part being defined by at least three points which are not present on a straight line. Downward is a direction opposite upward, or in other words, a direction perpendicular to the ground contact surface of the crawler belt 5a, 5b, the direction facing toward the ground contact surface.

The plurality of imaging devices 30a, 30b, 30c, 30d stereoscopically capture a target which is present in front of the vehicle body 1B of the excavator 1. A target is at least one of a target to be worked on by the excavator 1, or in other words, a work target, a work target of a work machine other than the excavator 1, and a work target of a worker working at a construction site, for example. The plurality of imaging devices 30a, 30b, 30c, 30d detect a target from a predetermined position of the excavator 1, or in the embodiment, from a forward and upward position inside the cab 4. In the embodiment, three-dimensional measurement of a target is performed using a result of stereoscopic capturing by at least a pair of the imaging devices 30. A position where the plurality of imaging devices 30a, 30b, 30c, 30d are arranged is not limited to the forward and upward position inside the cab 4.

For example, of the plurality of imaging devices 30a, 30b, 30c, 30d, the imaging device 30c is taken as a reference. The four imaging devices 30a, 30b, 30c, 30d each have a coordinate system. The coordinate systems will be referred to as “imaging device coordinate system” as appropriate. In FIG. 2, only a coordinate system (xs, ys, zs) of the imaging device 30c, which is taken as the reference, is illustrated. An origin of the imaging device coordinate system is a center of each imaging device 30a, 30b, 30c, 30d, for example.

In the embodiment, a capturing range of each imaging device 30a, 30b, 30c, 30d is larger than a range which can be worked on by the work unit 2 of the excavator 1. Accordingly, a target in a range where the work unit 2 can perform excavation can be reliably stereoscopically captured by each imaging device 30a, 30b, 30c, 30d.

The vehicle body coordinate system (Xm, Ym, Zm) mentioned above is a coordinate system which takes, as a reference, an origin that is fixed in the vehicle body 1B, or in the embodiment, the swinging body 3. In the embodiment, the origin of the vehicle body coordinate system (Xm, Ym, Zm) is a center of a swing circle of the swinging body 3, for example. The center of the swing circle is present on the swing center axis Zr of the swinging body 3. A Zm-axis of the vehicle body coordinate system (Xm, Ym, Zm) is an axis which is the swing center axis Zr of the swinging body 3, and an Xm-axis is an axis which extends in the front-back direction of the swinging body 3, and which is perpendicular to the Zm-axis. The Xm-axis is a reference axis in the front-back direction of the swinging body 3. The Ym-axis is an axis which is perpendicular to the Zm-axis and the Xm-axis, and which extends in a width direction of the swinging body 3. The global coordinate system (Xg, Yg, Zg) mentioned above is a coordinate system which is measured by GNSS, and which takes an origin that is fixed in the earth.

The vehicle body coordinate system is not limited to the example of the embodiment. For example, the vehicle body coordinate system may take a center of the boom pin 13 as the origin of the vehicle body coordinate system. The center of the boom pin 13 is a center of cross section when the boom pin 13 is cut along a plane perpendicular to an extending direction of the boom pin 13, and is a center along the extending direction of the boom pin 13.

<Shape Measurement System, Control System of Work Machine, and Construction Management System>

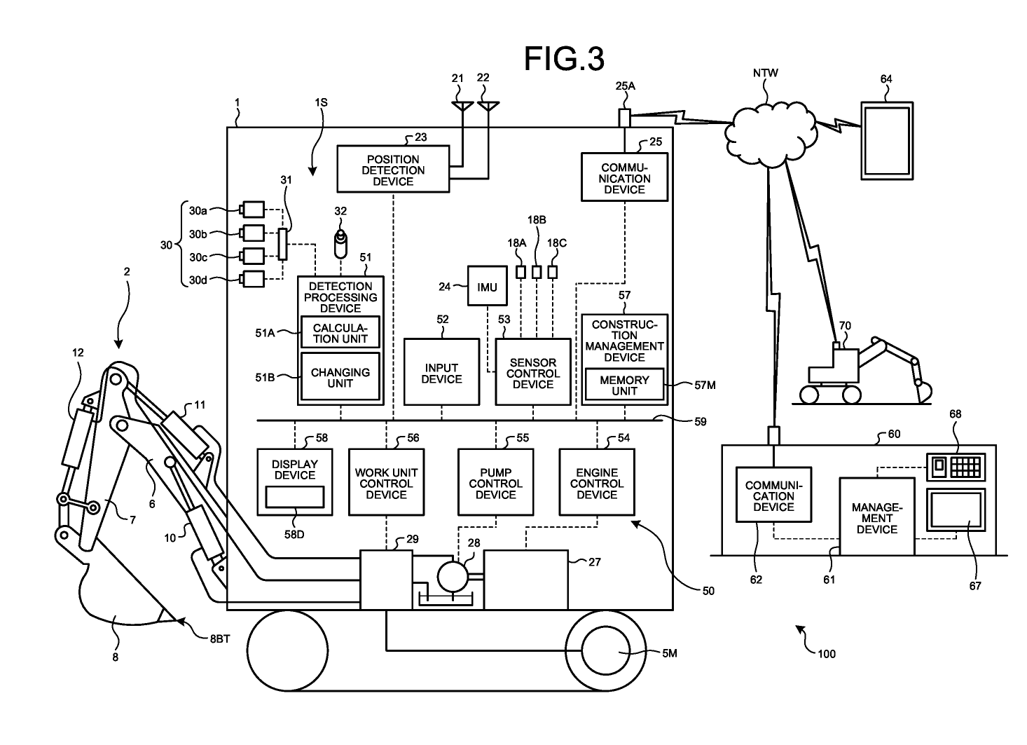

FIG. 3 is a diagram illustrating a shape measurement system 1S, a control system 50 of a work machine, and a construction management system 100 according to the embodiment. Device configurations of the shape measurement system 1S, the control system 50 of the work machine, and the construction management system 100 illustrated in FIG. 3 are only exemplary, and the example device configurations of the embodiment are not restrictive. For example, various devices included in the control system 50 do not have to be independent of each other. That is, functions of a plurality of devices may be realized by one device.

The shape measurement system 1S includes the plurality of imaging devices 30a, 30b, 30c, 30d, and a detection processing device 51. The control system 50 of the work machine (hereinafter referred to as “control system 50” as appropriate) includes the shape measurement system 1S, and various control devices configured to control the excavator 1. The shape measurement system 1S and the various control devices are provided in the vehicle body 1B of the excavator 1 illustrated in FIG. 1, or in the embodiment, the swinging body 3.

The various control devices of the control system 50 include an input device 52, a sensor control device 53, an engine control device 54, a pump control device 55, and a work unit control device 56, which are illustrated in FIG. 3. The control system 50 also includes a construction management device 57 configured to manage a state of the excavator 1 and a state of work by the excavator 1. The control system 50 also includes a display device 58 configured to display information about the excavator 1 or a construction guidance image on a screen 58D, and a communication device 25 configured to communicate with at least one of a management device 61 of a management facility 60 existing outside the excavator 1, another work machine 70, a mobile terminal device 64, and a device other than the management device 61 of the management facility 60. The control system 50 also includes a position detection device 23 and an IMU 24, as an example of a posture detection device, which are configured to acquire information necessary to control the excavator 1.

In the embodiment, the detection processing device 51, the input device 52, the sensor control device 53, the engine control device 54, the pump control device 55, the work unit control device 56, the construction management device 57, the display device 58, the position detection device 23, and the communication device 25 communicate with one another by being connected to a signal line 59. In the embodiment, the communication standard which use the signal line 59 is a controller area network (CAN), but this is not restrictive. In the following, when referring to the excavator 1, various electronic devices such as the detection processing device 51 and the input device 52 included in the excavator 1 are possibly referred to.

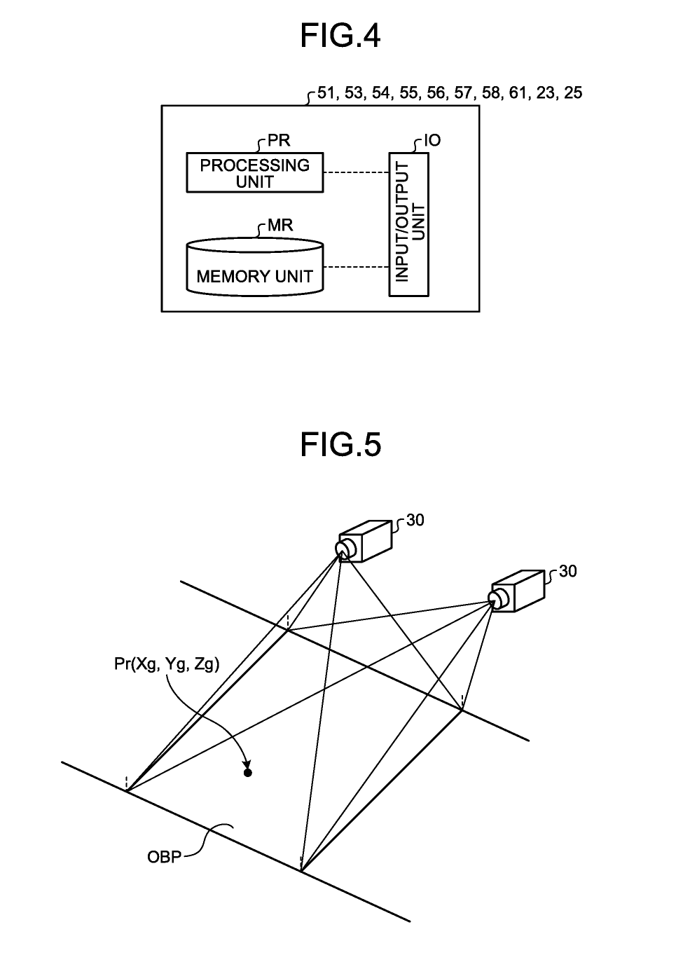

FIG. 4 is a diagram illustrating an example hardware configuration of the detection processing device 51 of the shape measurement system is, various appliances of the control system 50 of the work machine, and the management device 61. As illustrated in FIG. 4, in the embodiment, the detection processing device 51, the sensor control device 53, the engine control device 54, the pump control device 55, the work unit control device 56, the construction management device 57, the display device 58, the position detection device 23, and the communication device 25 included in the excavator 1, and the management device 61 each include a processing unit PR, a memory unit MR, and an input/output unit IO. The processing unit PR is realized by a processor, such as a central processing unit (CPU), and a memory, for example.

As the memory unit MR, at least one of a non-volatile or volatile semiconductor memory, such as a random access memory (RAM), a read only memory (ROM), a flash memory, a erasable programmable read only memory (EPROM), and an electrically erasable programmable read only memory (EEPROM; registered trademark), a magnetic disk, a flexible disk, and a magneto-optical disk is used.

The input/output unit IO is an interface circuit used by the excavator 1 or the management device 61 to transmit/receive data, signals and the like to/from another appliance or an internal device. Internal devices include the signal line 59 in the excavator 1.

The excavator 1 and the management device 61 each store, in the memory unit MR, a computer program for causing the processing unit PR to realize respective functions. The processing unit PR of the excavator 1 and the processing unit PR of the management device 61 each realize the function of the corresponding device by reading out and executing the computer program from the memory unit MR. Various electronic devices and the appliances of the excavator 1, and the management device 61 may be realized by dedicated hardware, or a plurality of processing circuits may realize each function in coordination with each other. Next, various electronic devices and appliances of the excavator 1 will be described.

The detection processing device 51 determines a position of a target, or more specifically, coordinates of the target in a three-dimensional coordinate system, by applying stereoscopic image processing on a pair of images of the target captured by a pair of imaging devices 30. In this manner, the detection processing device 51 performs three-dimensional measurement of a target by using a pair of images which are obtained by capturing one target by at least one pair of imaging devices 30. That is, at least one pair of imaging devices 30 and the detection processing device 51 are configured to three-dimensionally and stereoscopically measure a target. Stereoscopic image processing is a method of determining a distance to one target based on two images which are obtained by observing the target by two different imaging devices 30. The distance to a target is expressed by a range image which visualizes distance information with respect to the target by shading. The range image corresponds to shape information indicating a three-dimensional shape of the target.

The detection processing device 51 acquires information about a target which is detected, or in other words, captured, by at least one pair of imaging devices 30, and obtains shape information indicating a three-dimensional shape of the target from the acquired information about the target. In the embodiment, information about a target is generated and output by at least one pair of imaging devices 30 capturing the target. Information about the target is images of the target captured by at least one pair of imaging devices 30. The detection processing device 51 obtains the shape information by applying stereoscopic image processing on the images of the target, and outputs the shape information. In the embodiment, a work target or a worked target of the excavator 1 including at least one pair of imaging devices 30 is captured by at least one pair of imaging devices 30, but a work target or a worked target of the other work machine 70 may alternatively be captured by at least one pair of imaging devices 30.

In the embodiment, the work target or the worked target is a work target or a worked target of at least one of the excavator 1 including the imaging devices 30, the other work machine 70, a work machine other than the excavator 1, and a worker.

The detection processing device 51 includes a calculation unit 51A, and a changing unit 51B. The calculation unit 51A obtains shape information indicating a three-dimensional shape of a target by using information about the target detected by at least one pair of imaging devices 30, as a target detection unit, and outputs the shape information. More specifically, the calculation unit 51A obtains the shape information by applying stereoscopic image processing on a pair of images captured by at least one pair of imaging devices 30, and outputs the shape information.

The changing unit 51B changes a measurement condition which is used by the calculation unit 51A at the time of obtaining the shape information. Functions of the calculation unit 51A and the changing unit 51B are realized by the processing unit PR illustrated in FIG. 4. The measurement condition mentioned above is a measurement condition determining a condition used at the time of the calculation unit 51A obtaining the shape information, and will be described later in detail.

In the embodiment, the at least one pair of imaging devices 30 correspond to the target detection unit which is attached to the excavator 1, and which detects a target around the excavator 100 and outputs information about the target. The detection processing device 51 corresponds to a shape detection unit configured to output the shape information indicating a three-dimensional shape of a target by using information about the target detected by the at least one pair of imaging devices 30.

A hub 31 and an imaging switch 32 are connected to the detection processing device 51. The plurality of imaging devices 30a, 30b, 30c, 30d are connected to the hub 31. The imaging devices 30a, 30b, 30c, 30d and the detection processing device 51 may be connected without using the hub 31. A result of detection of a target, or in other words, a result of capturing a target, by the imaging devices 30a, 30b, 30c, 30d is input to the detection processing device 51 through the hub 31. The detection processing device 51 acquires, through the hub 31, the result of capturing of the imaging devices 30a, 30b, 30c, 30d, or in the embodiment, an image of the target. In the embodiment, when the imaging switch 32 is operated, at least one pair of imaging devices 30 capture the target. The imaging switch 32 is installed near the operation device 35 inside the cab 4 illustrated in FIG. 2. An installation position of the imaging switch 32 is not limited thereto.

The input device 52 is a device for inputting commands and information and for changing settings with respect to the shape measurement system 1S and the control system 50. For example, the input device 52 is keys, a pointing device, and a touch panel, but is not limited thereto. The screen 58D of the display device 58 described later may be provided with a touch panel so as to provide the display device 58 with an input function. In this case, the control system 50 does not have to include the input device 52.

Sensors and the like configured to detect information about a state of the excavator 1 and information about a state of surroundings of the excavator 1 are connected to the sensor control device 53. The sensor control device 53 outputs information acquired from the sensors and the like after converting the information into a format that can be handled by other electronic devices and appliances. Information about a state of the excavator 1 is information about a posture of the excavator 1, information about a posture of the work unit 2, and the like. In the example illustrated in FIG. 3, the IMU 24, a first angle detection unit 18A, a second angle detection unit 18B, and a third angle detection unit 18C are connected to the sensor control device 53 as the sensors configured to detect information about a state of the excavator 1, but the sensors and the like are not limited thereto.

The IMU 24 detects and outputs acceleration and angular velocity applied to the IMU 24, or in other words, acceleration and angular velocity applied to the excavator 1. A posture of the excavator 1 can be grasped from the acceleration and angular velocity applied to the excavator 1. A device other than the IMU 24 may also be used as long as the posture of the excavator 1 can be detected. In the embodiment, the first angle detection unit 18A, the second angle detection unit 18B, and the third angle detection unit 18C are stroke sensors, for example. These detection units detect stroke lengths of the boom cylinder 10, the arm cylinder 11, and the bucket cylinder 12, respectively, and thereby indirectly detect a rotation angle of the boom 6 with respect to the vehicle body 1B, a rotation angle of the arm 7 with respect to the boom 6, and a rotation angle of the bucket 8 with respect to the arm 7. A position of a part of the work unit 2 in the vehicle body coordinate system can be grasped from dimensions of the work unit 2, and the rotation angle of the boom 6 with respect to the vehicle body 1B, the rotation angle of the arm 7 with respect to the boom 6, and the rotation angle of the bucket 8 with respect to the arm 7, which are detected by the first angle detection unit 18A, the second angle detection unit 18B, and the third angle detection unit 18C. For example, a position of a part of the work unit 2 is a position of the blade tips 8BT of the bucket 8. The first angle detection unit 18A, the second angle detection unit 18B, and the third angle detection unit 18C may be potentiometers or clinometers, instead of the stroke sensors.

The engine control device 54 controls an internal combustion engine 27, which is a power generation device of the excavator 1. For example, the internal combustion engine 27 is a diesel engine, but is not limited thereto. Alternatively, the power generation device of the excavator 1 may be a hybrid device combining the internal combustion engine 27 and a generator motor. The internal combustion engine 27 drives a hydraulic pump 28.

The pump control device 55 controls a flow rate of hydraulic oil that is discharged from the hydraulic pump 28. In the embodiment, the pump control device 55 generates a control command signal for adjusting the flow rate of hydraulic oil that is discharged from the hydraulic pump 28. The pump control device 55 changes the flow rate of hydraulic oil that is discharged from the hydraulic pump 28, by changing a swash plate angle of the hydraulic pump 28 by using the generated control signal. The hydraulic oil discharged from the hydraulic pump 28 is supplied to a control valve 29. The control valve 29 supplies the hydraulic oil supplied from the hydraulic pump 28 to hydraulic appliances such as the boom cylinder 10, the arm cylinder 11, the bucket cylinder 12, and a hydraulic motor 5M, and drives the hydraulic appliances.

The work unit control device 56 performs control of causing the blade tips 8BT of the bucket 8 to move along a target construction surface, for example. The work unit control device 56 corresponds to a work unit control unit. In the following, such control will be referred to as “work unit control” as appropriate. When performing work unit control, the work unit control device 56 controls the work unit 2 by controlling the control valve 29 in such a way that the blade tips 8BT of the bucket 8 move along a target construction surface included in target construction information, which is information which is to be achieved at the time of construction, for example.

For example, of the shape information obtained by the detection processing device 51, the construction management device 57 collects at least one of shape information indicating a construction result obtained by the excavator 1 working on a work target and shape information indicating a current landform of a target which is about to be worked on by the excavator 1, and causes a memory unit 57M to store the shape information. The construction management device 57 transmits the shape information stored in the memory unit 57M to the management device 61 or the mobile terminal device 64 through the communication device 25. The construction management device 57 transmits the shape information indicating a construction result, which is stored in the memory unit 57M, to the management device 61 or the mobile terminal device 64 through the communication device 25. The construction management device 57 may collect at least one of the shape information and the target construction information obtained by the detection processing device 51, and transmit the information to the management device 61 or the mobile terminal device 64 without storing the information in the memory unit 57M. The memory unit 57M corresponds to the memory unit MR illustrated in FIG. 4. In the following, the shape information indicating a construction result of the excavator 1 working on a work target will be referred to as “construction result” as appropriate.

The construction management device 57 may be provided in the management device 61, which is provided outside the excavator 1, for example. In this case, the construction management device 57 acquires, from the excavator 1, through the communication device 25, at least one of the shape information indicating the construction result and the shape information indicating the current landform of a target which is about to be worked on by the excavator 1.

For example, the construction result is shape information which is obtained by capturing a worked target by at least one pair of imaging devices 30 and by applying stereoscopic image processing on the capturing result by the detection processing device 51. In the following, the shape information indicating the current landform of a target which is to be worked on will be referred to as “current landform information” as appropriate. The shape information may be the shape information indicating a construction result or the shape information indicating a current landform. For example, the current landform information is shape information which is obtained by the detection processing device 51 when a target which is to be worked on by the excavator 1, the other work machine 70, a worker or the like is captured by at least one pair of imaging devices 30.

For example, the construction management device 57 collects a construction result after a day's work, and transmits the construction result to at least one of the management device 61 and the mobile terminal device 64, or collects the construction result several times during a day's work, and transmits the construction result to at least one of the management device 61 and the mobile terminal device 64. For example, the construction management device 57 may transmit, in the morning, before work is started, shape information of before work to the management device 61 or the mobile terminal device 64.

In the embodiment, the construction management device 57 collects the construction result two times during a day's work, at noon and after the work is finished, and transmits the construction results to the management device 61 or the mobile terminal device 64. The construction result may be a construction result which is obtained by capturing a worked range in the entire construction site, or may be a construction result obtained by capturing the entire construction site. The construction result which is transmitted to the management device 61 or the mobile terminal device 64 is preferably a construction result for a worked range, from the standpoint of suppressing an increase in capturing time, image processing time, and construction result transmission time.

In the embodiment, in addition to displaying information about the excavator 1 or a construction guidance image on the screen 58D of a display such as a liquid crystal display panel, the display device 58 determines a position of the work unit 2 in the case of execution of the work unit control described above. The position of the blade tips 8BT determined by the display device 58 is the position of the blade tips 8BT of the bucket 8 in the embodiment. The display device 58 acquires current positions of the antennas 21, 22 detected by the position detection device 23, the rotation angles detected by the first angle detection unit 18A, the second angle detection unit 18B and the third angle detection unit 18C, the dimensions of the work unit 2 stored in the memory unit MR, and output data of the IMU 24, and determines the position of the blade tips 8BT of the bucket 8 by using these pieces of information. In the embodiment, the display device 58 determines the position of the blade tips 8BT of the bucket 8, the position of the blade tips 8BT of the bucket 8 may be determined by a device other than the display device 58.

The communication device 25 is a communication unit according to the embodiment. The communication device 25 exchanges information with at least one of the management device 61 of the management facility 60, the other work machine 70, and the mobile terminal device 64, through communication over a communication network NTW. Of pieces of information exchanged by the communication device 25, information which is transmitted from the control system 50 to at least one of the management device 61, the other work machine 70, and the mobile terminal device 64 includes information about construction. Information about construction includes at least one of the shape information described above and information obtained from the shape information. For example, information obtained from the shape information includes, but is not limited to, the target construction information described above and shape information which is obtained by processing the shape information described above. Information about construction may be transmitted by the communication device 25 after being stored in the memory unit of the detection processing device 51, the memory unit of the input device 52, and the memory unit 57M of the construction management device 57, or may be transmitted without being stored.

In the embodiment, the communication device 25 communicates by wireless communication. Accordingly, the communication device 25 includes a wireless communication antenna 25A. For example, the mobile terminal device 64 is possessed by a manager managing work of the excavator 1, but such a case is not restrictive. The other work machine 70 includes a function for communicating with at least one of the excavator 1 including the control system 50, and the management device 61. The other work machine 70 may be the excavator 1 including the control system 50, an excavator not including the control system 50, or a work machine other than the excavator 1. The communication device 25 may also exchange information with at least one of the management device 61 of the management facility 60, the other work machine 70, and the mobile terminal device 64 through wired communication.

The construction management system 100 includes the management device 61 of the management facility 60, the shape measurement system 1S, the control system 50, and the excavator 1 including the control system 50. The construction management system 100 may also include the mobile terminal device 64. The number of excavators 1, including the control system 50, which are included in the construction management system 100 may be one or more. As illustrated in FIG. 3, the management facility 60 includes the management device 61, and a communication device 62. The management device 61 at least communicates with the excavator 1 through the communication device 62 and the communication network NTW. The management device 61 may also communicate with the mobile terminal device 64 and the other work machine 70. A wireless communication appliance may be installed in the excavator 1 and the other work machine 70 so that wireless communication can be directly performed. At least one of the excavator 1 and the other work machine 70 may include an appliance or an electronic device which is capable of performing processes which are performed by the management device 61 of the management facility 60 and the like.

The management device 61 receives at least one of the construction result and the current landform information from the excavator 1, and manages progress of construction.

<Construction of Target>

In the embodiment, the control system 50 obtains shape information which is information indicating a shape of a work target, by capturing, by using at least two of the plurality of imaging devices 30 illustrated in FIG. 2, a target to be worked on. For example, the control system 50 transmits the shape information to the management device 61 through the communication device 25. The management device 61 receives the shape information transmitted from the excavator 1, and uses the shape information for construction management.

<Capturing of Target and Generation of Shape Information>

FIG. 5 is a diagram for describing shape information obtained by the shape measurement system 1S of the work machine according to the embodiment. In the embodiment, a work target OBP, which is a part which is about to be worked on by the excavator 1, is in front of the excavator 1. The shape information is obtained from the work target OBP. In the case of generating the shape information from the work target OBP, the shape measurement system 1S causes at least one pair of imaging devices 30 to capture the work target OBP. In the embodiment, when an operator of the excavator 1 operates the imaging switch 32 illustrated in FIG. 3 and inputs a capturing command to the detection processing device 51, the detection processing device 51 causes at least one pair of imaging devices 30 to capture the work target OBP.

The detection processing device 51 of the shape measurement system 1S applies stereoscopic image processing on images of the work target OBP captured by the at least one pair of imaging devices 30, and thereby obtains position information, or in the embodiment, three-dimensional position information, of the work target OBP. The position information of the work target OBP obtained by the detection processing device 51 is information based on a coordinate system of the imaging devices 30, and is converted into position information in the global coordinate system. The position information of a target, such as the work target OBP, in the global coordinate system is the shape information. In the embodiment, the shape information is information including at least one position Pr(Xg, Yg, Zg) on a surface of the work target OBP in the global coordinate system. The position Pr(Xg, Yg, Zg) is coordinates in the global coordinate system, and is three-dimensional position information. The detection processing device 51 converts the position of the work target OBP obtained from the images captured by the at least one pair of imaging devices 30 into a position in the global coordinate system. A position on the surface of the work target OBP includes positions on the surface of work target OBP after work and during work.

The detection processing device 51 obtains, and outputs, the position Pr(Xg, Yg, Zg) on the surface of the work target OBP for an entire region of the work target OBP captured by the at least one pair of imaging devices 30. In the embodiment, the detection processing device 51 creates a data file of the obtained position Pr(Xg, Yg, Zg). The data file is a collection of n positions Pr(Xg, Yg, Zg), where n is an integer of one or more. The data file also corresponds to the shape information according to the embodiment.

In the embodiment, after creating the data file, the detection processing device 51 causes its memory unit to store the data file. The construction management device 57 may transmit the data file created by the detection processing device 51 from the communication device 25 to at least one of the management device 61, the mobile terminal device 64, and the other work machine 70, which are illustrated in FIG. 3.

In the embodiment, when the imaging switch 32 illustrated in FIG. 3 is operated, at least one pair of imaging devices 30 capture a target. The calculation unit 51A of the detection processing device 51 generates the shape information by applying stereoscopic image processing on the images captured by the imaging devices 30. The calculation unit 51A of the detection processing device 51 outputs the data file. The data file is transmitted to at least one of the management device 61 and the mobile terminal device 64 through the construction management device 57 and the communication device 25, or through the communication device 25.

To monitor surroundings of the excavator 1, the detection processing device 51 causes at least one pair of imaging devices 30 to capture the target every specific period of time, such as every 10 minutes. A three-dimensional image captured by at least one pair of imaging devices 30 is stored in the memory unit of the detection processing device 51, and when a certain amount of information is accumulated, transmission to the management device 61 is performed through the communication device 25. The three-dimensional image may be transmitted at a timing of transmission of the data file to the management device 61, or may be transmitted to the management device 61 as soon as the image is captured.

In the embodiment, the detection processing device 51 may allow three-dimensional measurement using the imaging devices 30 under the following conditions (permission conditions): that activation of a plurality of imaging devices 30, for example, is recognized by the detection processing device 51; that the signal line 59 is not disconnected; that output of the IMU 24 is stable; and that positioning by GNSS is fixed (normal). In the case where even one permission condition is not satisfied, the detection processing device 51 does not permit three-dimensional measurement using the imaging devices 30, even when the imaging switch 32 is operated. That output of the IMU 24 is stable means that the excavator 1 is standing still. By setting the conditions described above for three-dimensional measurement by the imaging devices 30, reduction in accuracy of measurement of a target is suppressed. The control system 50 may use one of the permission conditions, or does not have to use the permission conditions.

The data file transmitted from the excavator 1 is stored in the memory unit of the management device 61. In the case where the data file is transmitted to the mobile terminal device 64, the data file may be stored in the memory unit of the mobile terminal device 64. The management device 61 may obtain the landform of the construction site by integrating data files for a plurality of different locations. The management device 61 may perform construction management by using the landform of the construction site obtained from the data files for a plurality of different locations. In the case of integrating a plurality of data files, if there are a plurality of pieces of data for positions with same x-coordinate and y-coordinate, the management device 61 may prioritize one of the pieces of data according to a rule which is set in advance. For example, a rule which is set in advance may be for prioritizing latest position data.

As described above, various pieces of information about construction at a construction site can be obtained from a data file, which is the shape information. Processes of generating the current state information or determining the amount of embankment or the amount of soil that is removed, by using the data file, may be performed by any of the management device 61, the mobile terminal device 64, and the construction management device 57 of the excavator 1. Any of the management device 61, the mobile terminal device 64, and the construction management device 57 of the excavator 1 may perform the processes described above, and transmit results to other appliances through the communication network NTW. Results of the processes above may be transferred to other appliances by being stored in a storage device, instead of through communication.

<Changing of Measurement Condition>

As described above, the changing unit 51B of the detection processing device 51 of the shape measurement system 1S changes the measurement condition which is used at the time of obtaining the shape information. In this case, when a command (hereinafter referred to as “change command” as appropriate) to change the measurement condition is received through the signal line 59, the changing unit 51B changes the measurement condition. The change command is transmitted from the management device 61 or the mobile terminal device 64, for example, and is given to the changing unit 51B through the communication device 25 and the signal line 59. Alternatively, the change command may be given to the changing unit 51B from the input device 52 of the excavator 1. In the case where the change command is transmitted from the management device 61, the change command is given to the management device 61 through an input device 68.

The measurement condition may be a range for obtaining the shape information of a target, which is measured by the calculation unit 51A of the detection processing device 51, for example. More specifically, when a change command is received from the changing unit 51B, the calculation unit 51A of the detection processing device 51 can change the range of a target where the shape information is to be actually measured, in the information about the target captured by a pair of imaging devices 30, or in other words, an overlapping region in a pair of captured images. In the embodiment, a target is a current landform. Information about a target is images which are detected, or in other words, captured, by at least one pair of imaging devices 30. The shape information of a target is information about a three-dimensional shape of a current landform, which is generated by applying stereoscopic image processing on images of the target, which are information about the target.

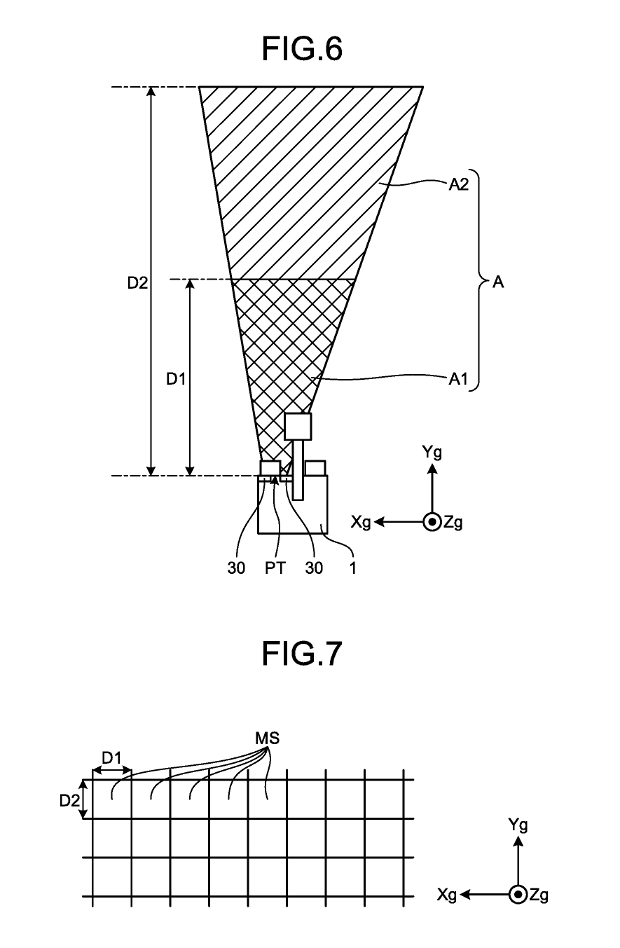

FIG. 6 is a diagram illustrating a range A where the shape information of a target is measured. The range A illustrated in FIG. 6 is a range where the calculation unit 51A obtains the shape information, and is a part or an entire region of an overlapping region of capturing ranges of a pair of imaging devices 30. In the case where a target is captured by a pair of imaging devices 30, information about the target is two images output from respective imaging devices 30.

When the range A where a pair of imaging devices 30 measure the shape information of a target is increased, shape information for a wide range can be obtained by one capturing by the pair of imaging devices 30. In the embodiment, the changing unit 51B of the detection processing device 51 illustrated in FIG. 3 changes the measurement range A of the target based on a change command from the mobile terminal device 64, the management device 61, or the input device 52 of the excavator 1, with the range A of the target which is to be measured by the pair of imaging devices 30 as the measurement condition.

In the embodiment, the changing unit 51B changes the measurement range A of the target as the measurement condition to a first range A1 and a second range A2, which is a range larger than the first range A1, according to a change command. The first range A1 is a range of a distance D1 from a position PT of the imaging devices 30, and the second range A2 is a range of a distance D2 from the position PT of the imaging devices 30, the distance D2 being larger than the distance D1.

In this manner, the changing unit 51B of the detection processing device 51 changes the measurement range A of the target captured by the pair of imaging devices 30, based on a change command. By making the measurement range A of the target a relatively large range, the detection processing device 51 can relatively reduce the number of times of capturing by at least one pair of imaging devices 30. Accordingly, the detection processing device 51 can efficiently measure the shape information. That the detection processing device 51 relatively increases the measurement range A of the target and measures the shape information is particularly effective in a large construction site.

On the other hand, if the detection processing device 51 relatively increases the measurement range A of the target and measures the shape information, measurement accuracy of the shape information for a region far away from the pair of imaging devices 30 (a region of the second measurement range A2, in FIG. 6, excluding the first measurement range A1) is relatively reduced than measurement accuracy for a region nearer to the pair of imaging devices 30 (the first measurement range A1 in FIG. 6). Accordingly, in a case where higher measurement accuracy is required with respect to the shape information, the detection processing device 51 can reduce the measurement range A of the target to a relatively small range, and thereby increase the accuracy of the shape information.

In the embodiment, when a change command is received from the changing unit 51B, the calculation unit 51A changes the range for measuring the shape information of the target in the information about the target captured by a pair of imaging devices 30, but such a case is not restrictive. For example, the calculation unit 51A may directly receive the change command from the management device 61, the mobile terminal device 64, or the input device 52 of the excavator 1, instead of through the changing unit 51B.

For example, if a device which is capable of outputting the change command is limited to the management device 61, an operator of the excavator 1 cannot freely switch the measurement range, and thus, measurement accuracy of the shape information can be prevented from being unintentionally reduced. That is, if only a site supervisor is allowed to switch the measurement range, the shape information of a target can be measured with expected accuracy. Moreover, even if the mobile terminal device 64 or the input device 52 of the excavator 1 is enabled to output a change command, if a password which only the site supervisor knows is required to output the change command, the shape information of a target can be measured with expected measurement accuracy, as in the case described above.

In the embodiment, the shape information is divided into a plurality of cells having a predetermined size and arranged at each x-coordinate and y-coordinate in the global coordinate system. A z-coordinate position of a target at each mesh position is defined as position information of the target in the mesh. A size of the mesh can be changed, and the size may be taken as one measurement condition.

FIG. 7 is a diagram illustrating a plurality of cells MS included in the position information. As illustrated in FIG. 7, the shape information output from the detection processing device 51 includes position information (z-coordinate position) of the target at each position where the cell MS is arranged. A cell at a part where the position of the target is not obtained by stereoscopic image processing does not include the position information of the target.

The cell MS has a rectangular shape. A length of one side of the cell MS is D1, and a length of a side perpendicular to the side having the length D1 is D2. The length D1 and the length D2 may be equal to each other or may be different from each other. Position information (x-coordinate, y-coordinate, z-coordinate) of a cell MS is a representative value of the position of the cell MS, and may be an average value of four corners of the cell MS or a position at a center of the cell MS, for example. Additionally, the shape of the cell MS is not limited to a rectangle, and may alternatively be a polygon such as a triangle or a pentagon.

The changing unit 51B of the detection processing device 51 can change the size of the cell MS in the shape information, based on a change command for changing the size of the cell MS. For example, when the changing unit 51B increases the size of the cell MS by increasing the lengths D1, D2 of the sides of the cell MS, the position information contained in the shape information is reduced (density of the position information is reduced). As a result, the amount of information in the shape information is reduced, but the measurement accuracy of the shape information is reduced. In the case where the size of the cell MS is relatively reduced, the position information contained in the shape information is increased, and fine position information of the target can be obtained from the shape information, but the amount of information in the shape information is increased.

In the embodiment, the size of the cell MS may be more increased, the further away from the position PT of the pair of imaging devices 30. For example, the size of the cell MS in the region of the second range A2 excluding the first range A1 may be made larger than the size of the cell MS in the region of the first range A1. As the distance from the pair of imaging devices 30 is increased, the position information of the cell MS becomes harder to measure due to influences from undulation of the landform and the like, but by increasing the size of the cell MS which is far away from the pair of imaging devices 30, the position information in the region of the cell MS becomes easier to measure.

In addition to the position information, the cell MS may include attribute information about accuracy of a position. For example, the attribute information about accuracy of a position may be accuracy information which is information about measurement accuracy at a measured position, or data about a distance from the pair of imaging devices 30 to a measured position, or in the case where switching can be performed between a plurality of measurement ranges or measurement methods, the attribute information may be data indicating which measurement range or measurement method was used to measure the position information. If measurement is performed for a region further away from the pair of imaging devices 30 in the range A where the shape information of the target is to be measured (obtained), the measurement accuracy of a position is reduced especially in a faraway region due to properties of landform measurement by the stereo camera. Accordingly, for example, the calculation unit 51A of the detection processing device 51 can add the attribute information about accuracy of a position to a measurement result (x, y, z coordinates) of the measured position. That is, the shape information includes, in addition to the position information, the attribute information about accuracy of a position for each measured position.

More specifically, in the case where measurement is performed with the first range A1 illustrated in FIG. 6 as the measurement range, the calculation unit 51A may uniformly add information indicating that the measured position accuracy is high to each measurement result for the first range A1. In the case where measurement is performed with the second range A2 as the range where the shape information of the target is measured (obtained), the calculation unit 51A may uniformly add information indicating that the measured position accuracy is low to each measurement result for the second range A2.

The calculation unit 51A may add information indicating that the position accuracy is high to the measurement result, or in other words, the position information of the cell MS, for the first range A1, and add information indicating that the position accuracy is low to the measurement result, or in other words, the position information of the cell MS, for the region of the second range A2 excluding the first region A1, regardless of which of the measurement range is used. The calculation unit 51A may add information that the position accuracy is high to a cell MS which is close to the pair of imaging devices 30, and add information indicating that the position accuracy is low to a cell MS which is far away from the pair of imaging devices 30, regardless of whether the region is the first region A1 or the second region A2, the attribute information about the accuracy being set stepwise according to the distance. That is, the calculation unit 51A may add the attribute information about accuracy of a position to each cell MS, which is a predetermined region in the shape information, and also change the attribute information about accuracy of a position added to the cell MS according to a distance from the pair of imaging devices 30, which is the target detection unit.

With respect to the information that the position accuracy is high and the information that the position accuracy is low, high/low is set with reference to reference position accuracy which is determined in advance. Moreover, the high/low of position accuracy may be set such that the position accuracy is high for the first range A1, and that the position accuracy is stepwise or continuously reduced as the distance from the first range A1 is increased, for example.

The management device 61 which acquires a data file, which is the shape information, may thus adopt position information with relatively high accuracy, based on the attribute information about accuracy, at the time of integrating a plurality of data files. As a result, the position accuracy of landform of a construction site obtained by integration can be increased.

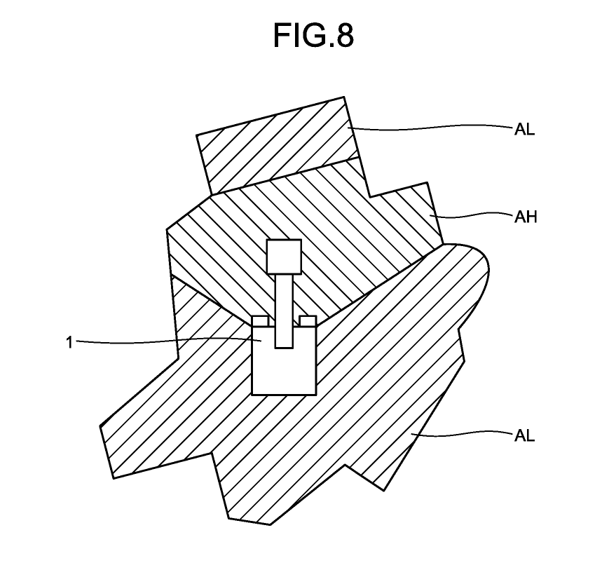

FIG. 8 is a diagram illustrating an example in which a display device performs display in a manner allowing identification of the attribute information about accuracy of a measured position. A display device, or in the embodiment, at least one of a display device 67 of the management device 61, the mobile terminal device 64, and the display device 58 of the excavator 1, may perform display in a manner allowing identification of the attribute information about accuracy of a measured position, at the time of displaying current landform data, of a target of construction, measured by a pair of imaging devices 30. For example, the display device displays the attribute information about accuracy of a position together with the shape information. At this time, the display device displays the shape information by changing a display mode according to the attribute information about accuracy of the position. That is, the attribute information about accuracy of the position is indicated by the display mode of the shape information. In the example illustrated in FIG. 8, the display mode is changed between a region AH with high position accuracy and a region AL with low position accuracy. This allows a region with low position measurement accuracy to be easily identified, and thus, re-measurement by a measurement method with high accuracy may be efficiently performed as necessary.

In the case where the position information (z-coordinate position) of a target is measured, in the region of a certain cell, by the calculation unit 51A of the detection processing device 51, the position information of the cell is stored, but in the case where the position information is not measured in the region of the cell, the position information of the cell is not stored. Also in such a case, the position information of the cell where the position information is not measured can be estimated by using a plurality of cells which are in the periphery of the cell and for which the position information is stored. As one measurement condition, it is possible to allow selection of whether or not to estimate the position information of a cell for which the position information is not measured.

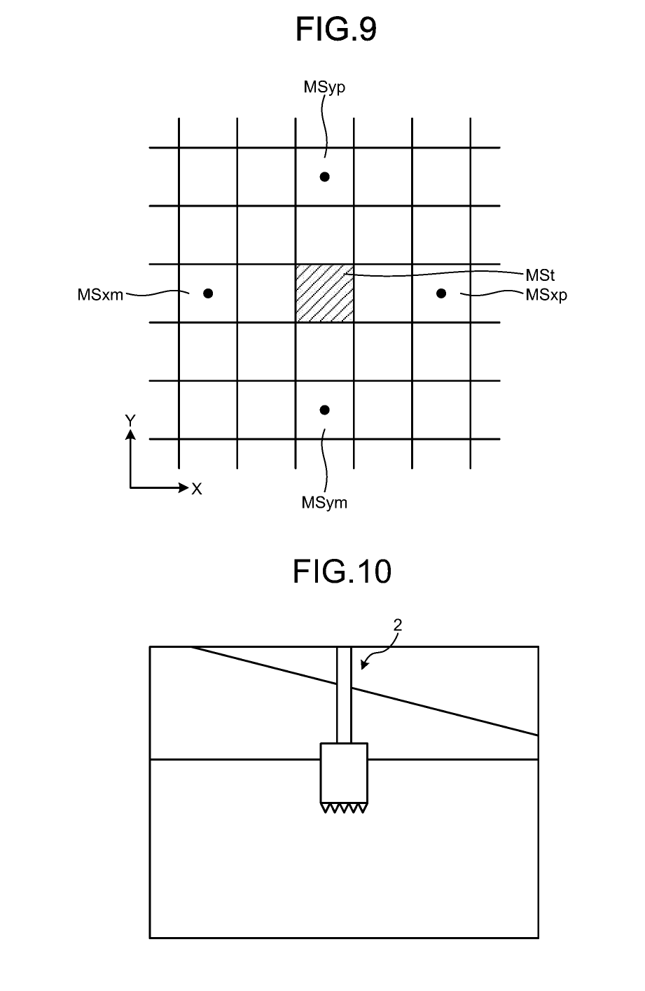

FIG. 9 is a diagram illustrating cells MSxp, MSxm, MSyp, MSym including the position information and a cell MSt not including the position information. The calculation unit 51A of the detection processing device 51 is capable of obtaining the position information of the cell MSt not including the position information of a target, by using at least two cells including the position information of the target. The changing unit 51B selects whether or not to obtain the position information of the cell MSt not including the position information of the target, based on a change command.

At the time of obtaining the position information of a cell MSt, the calculation unit 51A searches for the cell MSt from the shape information. In the case of finding a cell MSt not including the position information, the calculation unit 51A searches for cells including the position information in both a positive direction and a negative direction of an X-direction, as a first direction, and of a Y-direction, with the cell MSt as a reference, for example. If, as a result of search, there are cells including the position information, the calculation unit 51A obtains the position information of the cell MSt by interpolation, by using the position information of at least two of the cells MSxp, MSxm, MSyp, MSym which are the nearest in the respective directions. The directions of search are not limited to the X-direction and the Y-direction, and search may be performed in oblique directions. The method of interpolation may be a known method such as bilinear interpolation.

The detection processing device 51 obtains the position information of the cell MSt not including the position information of the target by using at least two cells including the position information of the target, and thus, the position information can also be obtained for a part where the shape information is not obtained by stereoscopic image processing. Because whether or not to obtain the position information of a cell not including the position information of the target can be selected, it is possible not to obtain the position information of a cell not including the position information of the target in a case where the position information is not necessary, for example. This enables the amount of information to be reduced with respect to the shape information.

FIG. 10 is a diagram illustrating a noise and the work unit included in the shape information. In the embodiment, the calculation unit 51A may remove, from the shape information, a noise such as an electric wire, a tree, a house or the like. In this case, whether or not a noise is to be removed by the calculation unit 51A may be used as a measurement condition. As a case of removal of a noise, the following case is conceivable. For example, in the case where the detection processing device 51 detects an electric wire at a predetermined position (cell located at certain x-coordinate and y-coordinate) of a target, the detection processing device 51 possibly simultaneously detects the current landform at the same position (the same cell) of the target. In this case, the position information is present at two heights (z-coordinate) at one position (one cell). In such a case, unreliable data, or in other words, a noise, can be removed by not measuring the position information at the position (cell).

In the embodiment, the measurement condition may be one of selection of whether or not a noise is to be removed by the calculation unit 51A, and a size of a noise which is to be removed by the calculation unit 51A. In the case where selection of whether or not a noise is to be removed by the calculation unit 51A is used as the measurement condition, the changing unit 51B determines, based on a change command, whether to cause the calculation unit 51A to remove a noise in the shape information or not. The calculation unit 51A removes the noise in the shape information or leaves the noise as it is, based on the determination result of the changing unit 51B. According to such a process, if removal of a noise is not necessary, a processing load of the calculation unit 51A is reduced.

In the case where the size of a noise which is to be removed by the calculation unit 51A is used as the measurement condition, the changing unit 51B changes, based on a change command, the size of a noise which is to be removed by the calculation unit 51A. The calculation unit 51A removes a noise which is greater than the size after change by the changing unit 51B. According to such a process, the calculation unit 51A does not remove a noise which is small enough not to require removal, and a processing load of the calculation unit 51A is reduced.

The shape measurement system 1S includes at least one pair of imaging devices 30, the calculation unit 51A configured to obtain shape information indicating a three-dimensional shape of a target, by using information about the target detected by the at least one pair of imaging devices 30, and configured to output the shape information, and the changing unit 51B configured to change a measurement condition which is used at the time of the calculation unit 51A obtaining the shape information. The measurement condition is used at the time of the calculation unit 51A obtaining the shape information by applying stereoscopic image processing on the information about the target obtained by the at least one pair of imaging devices 30. Therefore, the shape measurement system 1S is enabled to change, by the changing unit 51B, the measurement condition which is used at the time of execution of stereoscopic image processing.

A shape measurement method according to the embodiment includes a step of detecting a target worked on by a work machine, and outputting information about the target, and a step of obtaining shape information indicating a three-dimensional shape of the target, by using the output information about the target, and of outputting the shape information, where a measurement condition which is used at the time of obtaining the shape information is changeable. Accordingly, with the shape measurement method, the measurement condition which is used at the time of execution of stereoscopic image processing can be changed.

The work machine is not limit to an excavator, and may be a work machine such as a wheel loader or a bulldozer, as long as work, such as excavation and transportation, of a work target can be performed.

In the embodiment, the shape information is divided into a plurality of cells having a predetermined size, but such a case is not restrictive, and a current shape may be measured and managed based on a point (based on xy coordinates) measured by a stereo camera, without using cells, for example.

In the embodiment, a description is given assuming that at least one pair of imaging devices 30 are the target detection unit, but the target detection unit is not limited thereto. For example, a 3D scanner, such as a laser scanner, may be used as the target detection unit, instead of the pair of imaging devices 30. The 3D scanner detects information about a target, and the calculation unit 51A can calculate the shape information of the target based on the information about the target detected by the 3D scanner.

In the embodiment, the detection processing device 51 performs stereoscopic processing and three-dimensional measurement processing based on a plurality of camera images, but the detection processing device 51 may transmit the camera images to outside, and stereoscopic image processing may be performed by the management device 61 of the management facility 60, or by the mobile terminal device 64.

Heretofore, an embodiment has been described, but the embodiment is not limit to the contents described above. The structural elements described above include those that can be easily assumed by persons skilled in the art, or those that are substantially the same, or in other words, equivalent. The structural elements described above may be combined as appropriate. At least one of various omissions, substitutions, and modifications are possible with respect to the structural elements within the scope of the embodiment.

### REFERENCE SIGNS LIST

1 EXCAVATOR
1B VEHICLE BODY
1S SHAPE MEASUREMENT SYSTEM
2 WORK UNIT
3 SWINGING BODY
4 CAB
5 TRAVELING BODY
23 POSITION DETECTION DEVICE
25 COMMUNICATION DEVICE
30, 30a, 30b, 30c, 30d IMAGING DEVICE (TARGET DETECTION UNIT)
50 CONTROL SYSTEM OF WORK MACHINE
51 DETECTION PROCESSING DEVICE
51A CALCULATION UNIT
51B CHANGING UNIT
52 INPUT DEVICE
57 CONSTRUCTION MANAGEMENT DEVICE
57M MEMORY UNIT
60 MANAGEMENT FACILITY
61 MANAGEMENT DEVICE
64 MOBILE TERMINAL DEVICE
100 CONSTRUCTION MANAGEMENT SYSTEM

1. A shape measurement system comprising:
a target detection unit, attached to a work machine, configured to detect a target in a periphery of the work machine; and
a calculation unit configured to obtain shape information indicating a three-dimensional shape of the target, by using a detection result detected by the target detection unit,
wherein the calculation unit is configured to change a range where the shape information is obtained.

2. The shape measurement system according to claim 1, wherein
attribute information about accuracy of a position is added to the shape information.

3. The shape measurement system according to claim 1, wherein the calculation unit is configured to receive a signal for changing the range where the shape information is obtained, from a management device, a mobile terminal device, or an input device of the work machine.

4. The shape measurement system according to claim 2, wherein
in a case of a first measurement range that is a range where the shape information of the target is obtained, information indicating that accuracy of the position is high is added to the shape information, for a measurement result for the first measurement range.

5. The shape measurement system according to claim 4, wherein
in a region excluding the first measurement range from a second measurement range that is a region larger than the first measurement range and where the shape information of the target is obtained, information indicating that accuracy of the position is low is added to the shape information, for a measurement result for the region.

6. The shape measurement system according to claim 2, wherein the attribute information about accuracy of the position, which is added to a measured position, is changed according to a distance of the measured position from the target detection unit.

7. The shape measurement system according to claim 2, comprising a display device configured to display the attribute information about accuracy of the position, together with the shape information.

8. The shape measurement system according to claim 2, wherein
the shape information is divided into a plurality of cells, and
each cell includes position information of the target and the attribute information about accuracy of the position.

9. The shape measurement system according to claim 2, wherein
the shape information is divided into a plurality of cells, and
the calculation unit is configured to obtain the position information of a cell not including the position information of the target, by using at least two of the cells including the position information of the target.

10. The shape measurement system according to claim 2, wherein
the shape information is divided into a plurality of cells, and
sizes of the cells are set to increase as a distance from a position of the target detection unit is increased.

11. A work machine comprising a shape measurement system according to any claim 1.

12. A shape measurement method comprising:
detecting, by a work machine, a target in a periphery of the work machine; and
obtaining shape information indicating a three-dimensional shape of the target, by using a result of the detecting, and outputting the shape information,
wherein a range where the shape information is obtained is changeable.
